(19) United States
(12) Patent Application Publication
(10) Pub. No.: US 2015/0161534 A1
(43) Pub. Date: Jun. 11, 2015

(54) EVENT MANAGEMENT SYSTEM AND METHOD

(71) Applicant: Calfee, Halter & Griswold LLP, Cleveland, OH (US)

(72) Inventors: Nenad Pejic, Broadview Heights, OH (US); Christopher S. Williams, Westlake, OH (US); Chad S. DeHart, Avon, OH (US); Keith J. Lubbers, Cleveland Heights, OH (US)

(21) Appl. No.: 14/561,809

(22) Filed: Dec. 5, 2014

Related U.S. Application Data
(60) Provisional application No. 61/912,362, filed on Dec. 5, 2013.

(51) Int. Cl. G06Q 10/06

(52) U.S. Cl. CPC G06Q 10/0631

(57) ABSTRACT

Systems and methods including a server based network that can store event and event ticket request information. An interactive list of available event tickets can be displayed on a remote computer to manage electronic requests for event tickets. Electronic messages associated with the ticket requests can be sent electronically to one or more administrators for disposition of the event ticket request. Further electronic messages may be sent based on an administrator's grant or deny disposition of the request. Reminder and availability messages may be sent. Usage and requester data can be tracked. Groups of requesters may be identified to control various messages and the display of request information.

### CROSS REFERENCE TO RELATED APPLICATIONS

This application claims priority to, and the benefits of, U.S. provisional application Ser. No. 61/912,362, filed on Dec. 5, 2013, which is incorporated by reference herein in full.

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### BACKGROUND

Many businesses and organizations purchase and use event tickets for the purpose of client and business development. These events tickets include, for example, sporting events, plays and shows, concerts and orchestras, and any other event(s) suitable for client and/or business development. Hence, within a business or organization, there exists a need to efficiently administer the function of event tickets.

### SUMMARY

In one embodiment, a system and method manages the event ticket function. The system and methods can be web-based via an intranet or Internet, or standalone. Event data such as, for example, a calendar of events, the name of the event, time of the event, and ticket information are stored and tracked. Each event ticket requester can have a profile for ranking the requestor among a plurality of requesters to prioritize event ticket administration. A requester's profile can also be used to track the requester's number of granted, denied and total requests, and other associated data. Requests for event tickets generate messages, alerts and/or reminders to administrators and/or requesters. Decisions by administrators to grant or deny requests generate associated messages to the requestors informing them that a decision has been made on their requests.

In another embodiment, the system and method includes auto-allocation. Auto-allocation logic monitors the event ticket data for events where no requests have been made. In this case, the auto-allocation automatically allocates or grants those tickets to the administrators in order to find an appropriate use for the event tickets. Upon auto-allocation, messages are generated to the administrators and the event ticket data is updated to reflect those tickets have been auto-allocated or granted to the administrators. The administrators may then subsequently adjust the data to indicate if any requesters have been found for the auto-allocated tickets

In yet another embodiment, a event ticket usage logic can be included. The usage logic can track planned event ticket usage and/or subsequent event ticket usage. This includes the requestor information (e.g., requester profile and associated data), event information, client or prospect entertained, topics discussed, expenses, etc. Any usage data relative to the event it be tracked.

### BRIEF DESCRIPTION OF DRAWINGS

In the accompanying drawings which are incorporated in and constitute a part of the specification, embodiments of the invention are illustrated, which, together with a general description of the invention given above, and the detailed description given below, serve to example the embodiments of this invention.

FIG. 1 is an exemplary overall system diagram in accordance with one embodiment;

FIG. 2 is an exemplary block diagram of one embodiment of the event ticket logic.

FIG. 3 is an exemplary flowchart of one embodiment of event management logic.

FIG. 4 is an exemplary flowchart of one embodiment of administration (admin) logic.

FIG. 5 is an exemplary flowchart of one embodiment of auto-allocation logic.

FIG. 6 is an exemplary flowchart of one embodiment of messaging/notification logic.

FIG. 7 is an exemplary flowchart of one embodiment of usage logic.

FIG. 8 is an exemplary illustration of one embodiment of an event calendar display.

FIG. 9 is an exemplary illustration of one embodiment of an event request display.

FIG. 10 is an exemplary illustration of one embodiment of a new request display.

FIG. 11 is an exemplary illustration of one embodiment of a requester profile display.

FIG. 12 is an exemplary illustration of one embodiment an event profile management display.

FIG. 13 is an exemplary illustration of another embodiment of an event profile management display.

FIG. 14 is an exemplary illustration of one embodiment of an admin display.

FIG. 15 is an exemplary illustration of on embodiment of an event usage display.

### DETAILED DESCRIPTION

The following includes exemplary definitions of exemplary terms used throughout the disclosure. Both singular and plural forms of all terms fall within each meaning:

“Software”, as used herein, includes but is not limited to one or more computer readable and/or executable instructions that cause a computer or other electronic device to perform functions, actions, and/or behave in a desire manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Logic,” synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Browser” as used herein includes, but is not limited to, any computer program used for accessing sites, data or information on a network (as the World Wide Web) including, for example, toolbars and application programs. The browser may be configured to access, download, and/or execute logic and/or software located remote computers. Examples of browsers include Internet Explorer by Microsoft Corp. of Redmond, Washington and Safari by Apple Corp. of Cupertino, California. Other browser programs are also applicable.

While the above exemplary definitions have been provided, it is Applicant's intention that the broadest reasonable interpretation consistent with this specification be used for these and other terms.

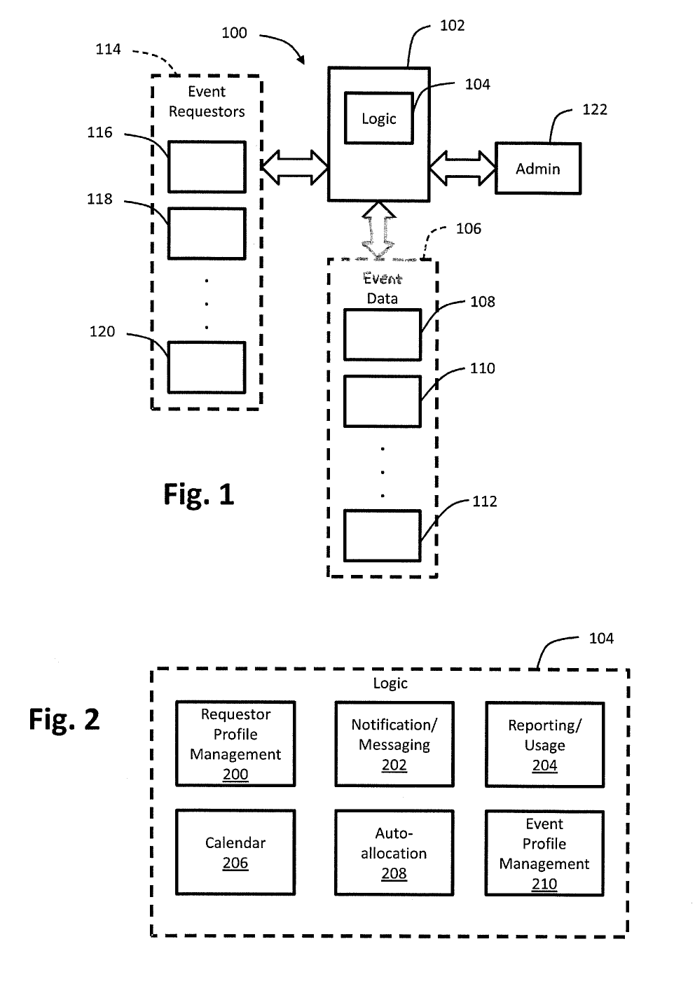

Illustrated in FIG. 1 is an exemplary event ticket system 100 in accordance with one embodiment of the present invention. System 100 includes, for example, a server 102 that interacts with event requesters 114, event data 106, and administration 122. Server 102 includes event management logic 104, which will be described in more detail hereinafter. Server 102 receives inputs and sends outputs to event requesters 114 via a networked environment. The network environment may be wide, local, wireless, or wired. In one embodiment, event requesters interact with event management logic 104 through an Internet protocol. Data regarding events is transferred back and forth between event requesters 114 and server 102 over the network. Event requesters 114 can include a plurality of requesters and 116-120. Event requesters 114 can use any one of a plurality of forms of client-type devices to interact with server 102. These include Web browsers, desktop computers, laptop computers, tablet computers, smart phones, and other similar type devices.

Server 102 also reads and stores event data 106. Event data 106 can include any data associated with an event. It can include, for example, the name of the event, the time of the event, the type of tickets for the event, event usage data (e.g., requester information, client or prospect information, expenses, etc.) This list is not intended to be exhaustive but merely illustrative of data that can be associated with events and event usage. Event data 106 can include, for example, data regarding a plurality of events 108-112. Events can include sporting events, plays and shows, concerts and orchestras, and any other event(s) suitable for client and/or business development and/or entertainment.

Server 102 also interacts with an admin 122. Server 102 sends and receives information from admin 122. In one embodiment, admin 122 provides the inputs necessary to make decisions regarding the grant, denial, or other actions regarding requests for event tickets. In other embodiments, admin 122 provides for other administrative functions such as, for example, the input of requester and event profiles and their management. In another embodiment, admin 122 provides for the modification of event request data, usage data, and/or other data from an administrative perspective.

Referring now to FIG. 2, one embodiment of event management logic 104 is illustrated. Event management logic 104 includes, for example, requester profile management logic 200, notification/messaging logic 202, reporting/usage logic 204, calendar logic 206, auto-allocation logic 208, and/or event profile management logic 210. In other embodiments, addition or fewer logic modules may be present.

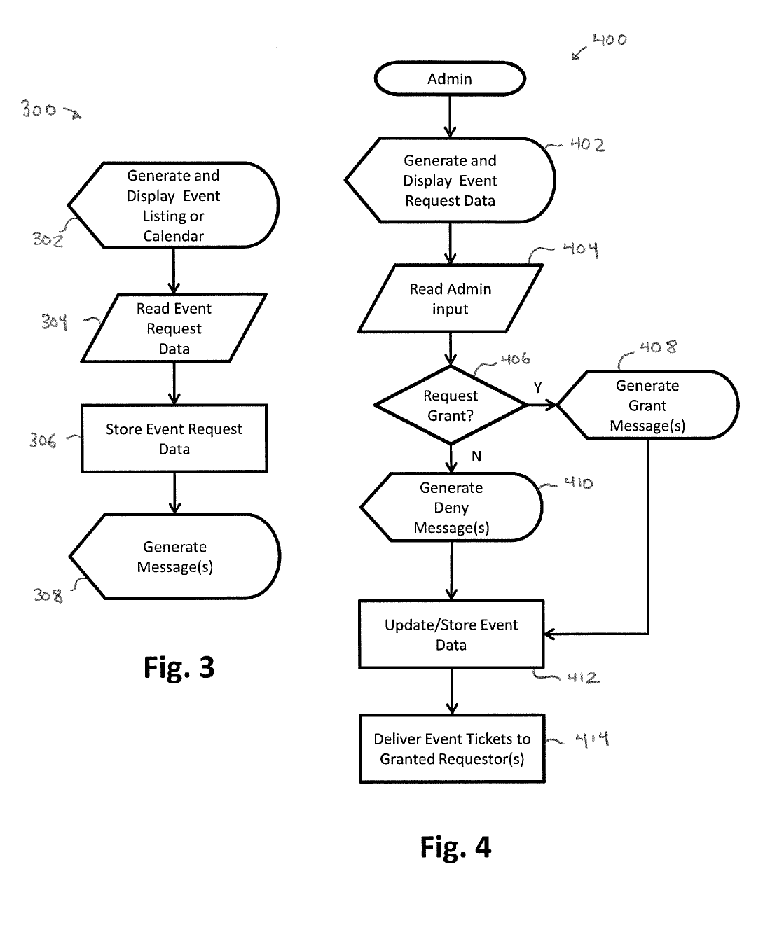

Illustrated in FIG. 3-7 are exemplary methodology/logic for managing event data and information. As illustrated, the blocks represent functions, actions and/or events performed therein. It will be appreciated that electronic and software applications involve dynamic and flexible processes such that the illustrated blocks can be performed in other sequences different than the one shown. It will also be appreciated by one of ordinary skill in the art that elements embodied as software may be implemented using various programming approaches such as machine language, procedural, object oriented or artificial intelligence techniques. It will further be appreciated that, if desired and appropriate, some or all of the software can be embodied as part of a device's operating system.

In the figures, the elements denote “processing blocks” and represent computer software instructions or groups of instructions. The diamond shaped elements denote “decision blocks” and represent computer software instructions or groups of instructions which affect the execution of the computer software instructions represented by the processing blocks. Alternatively, the processing and decision blocks represent steps performed by functionally equivalent circuits such as a digital signal processor circuit or an application specific integrated circuit (ASIC). The flow diagram does not depict syntax of any particular programming language. Rather, the flow diagram illustrates the functional information one skilled in the art may use to fabricate circuits or to generate computer software to perform the processing of the system. It should be noted that many routine program elements, such as initialization of loops and variables and the use of temporary variables are not shown.

Illustrated in FIG. 3 is one embodiment of a flowchart showing logic 300 for generating event display and request processing. In one embodiment, one or more requesters access a server-based event management system. A display or listing of events is generated on the requester's client-based system (e.g., web browser). A requester may then choose from the display or listing one or more events from which to make a request for tickets. An event request is then stored by the system and one or more messages are generated to the requesters and/or administrators informing them of the status of the request (e.g., confirmation of request, granting, denial, special, etc.)

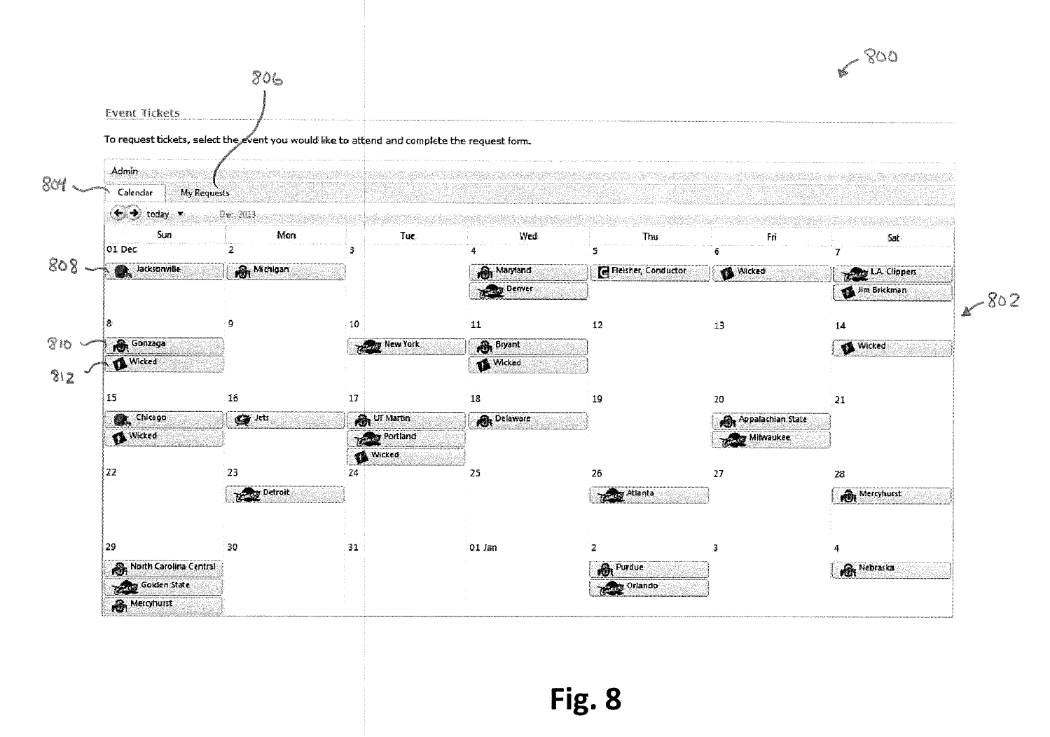

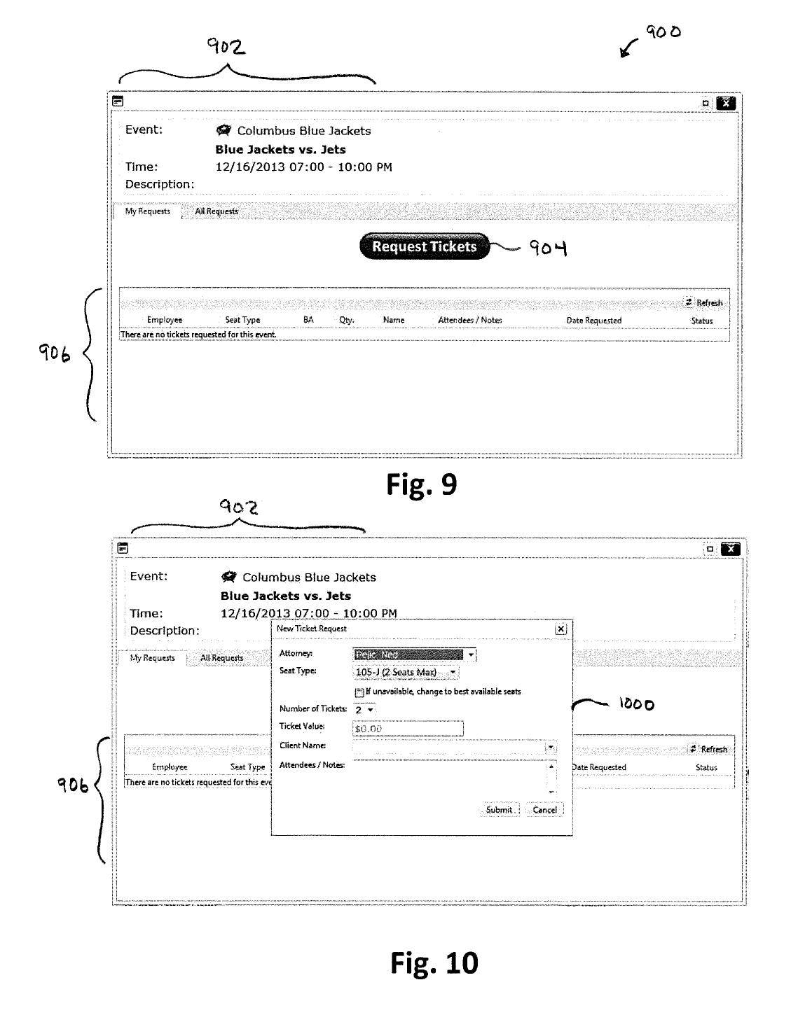

Still referring to FIG. 3, in block 302, the system logic generates and displays an event listing. Event listing can be any form including, for example, an interactive calendar, listing, or other display. One example of a calendar display is shown in FIG. 8. The display is interactive in that it contains links to functions and routines for processing requests for tickets to the events. In block 304, the logic reads event request data generated by one or more requesters. In one example, a requester may select an event on a given calendar day to trigger subsequent interactive displays for capturing the requester's and event's data. This event request data is then stored in block 306 for use in subsequent routines and functions. The subsequent routines and functions include, for example, block 308 were appropriate messages are generated by the logic to the requester and/or administrators. In one example, the generated messages include an e-mail to the requester confirming that the system has received a request for tickets to a particular event and that the request is under consideration. The message may include additional details such as, for example, data about the event including location, time, scheduled attendees, etc. This same or similar message can also be generated and e-mailed to the administrators. In this manner, the requester and the administrators can both have confirmation that a request to an event has been placed with the system.

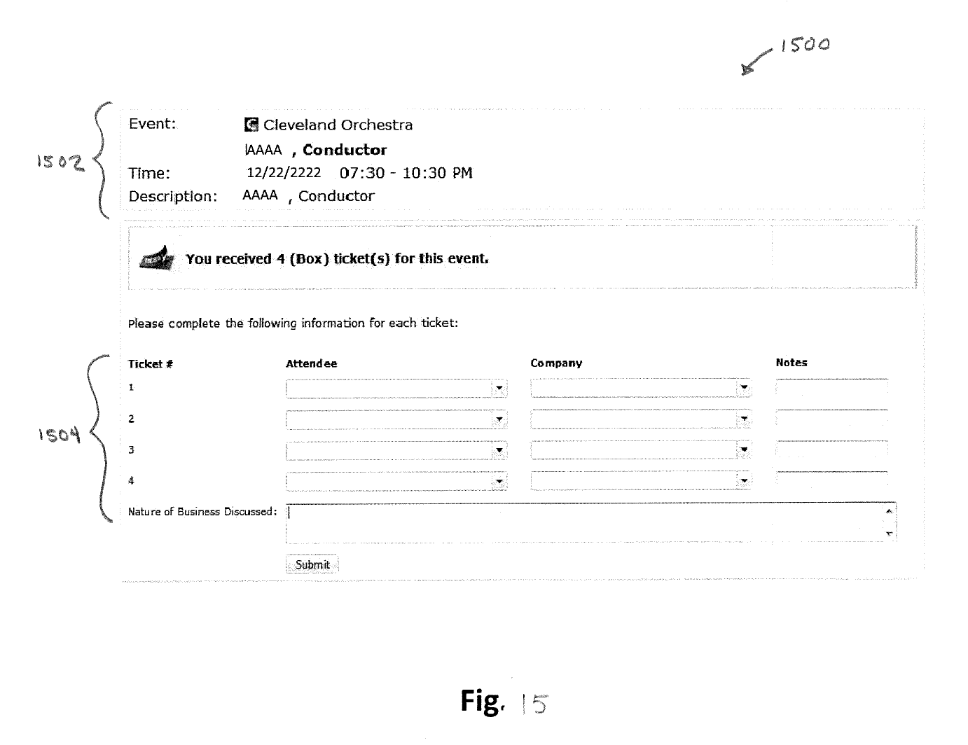

Referring now to FIG. 4, one embodiment of the administration logic 400 shown. In block 402, the logic generates and displays event request data. Examples of such displays are shown in FIGS. 14 and 15. These displays are interactive and allow the administrators to input data regarding a request to attend an event. In block 404, the logic reads the administrators' input, which can be in the form of an input granting, denying, or modifying, the request. Other administrator inputs can include canceling or deleting a request and/or indicating their request is “special.”

In block 406, if the request is granted, the logic advances to block 408 and generates messages indicating the request has been granted. In one embodiment, these messages can take the form of an e-mail to the requester indicating that the request has been granted and can include detailed information regarding the nature of the event. In block 406, if the request is denied or not granted, logic advances to block 410 and generates messages indicating the request has not been granted. Again, these messages can take the form of an e-mail to the requester indicating that the request is not been granted and can include detailed information regarding the nature of the event. Optionally, the same or similar type messages can be sent to the administrators. In this manner, the requester and administrators have a record of the grant or denial of event requests. In one embodiment, when the request has been granted, the message to the requester includes an “add appointment” function that allows the requester to add the event to the requester's appointment calendar.

After either the grant or denial of a request, the event data is updated and stored with this information in block 412. This information can include the requester's identity/profile and the associated data indicating the grant or denial of the request. In one embodiment, this event data can be used by the usage and or reporting logic to keep track of how many grants and/or denials have been associated with a particular requester. This information can be subsequently used to assist the administrators in the decision-making process of granting and denying requests where multiple requests a been made for a subsequent particular event. The event data can also include the date and time of each grant or denial of a request for each requester. In block 414, the event tickets are delivered to the granted requester(s). This delivery can be either electronic via a code (e.g., bar coded ticket) or via a physical ticket medium.

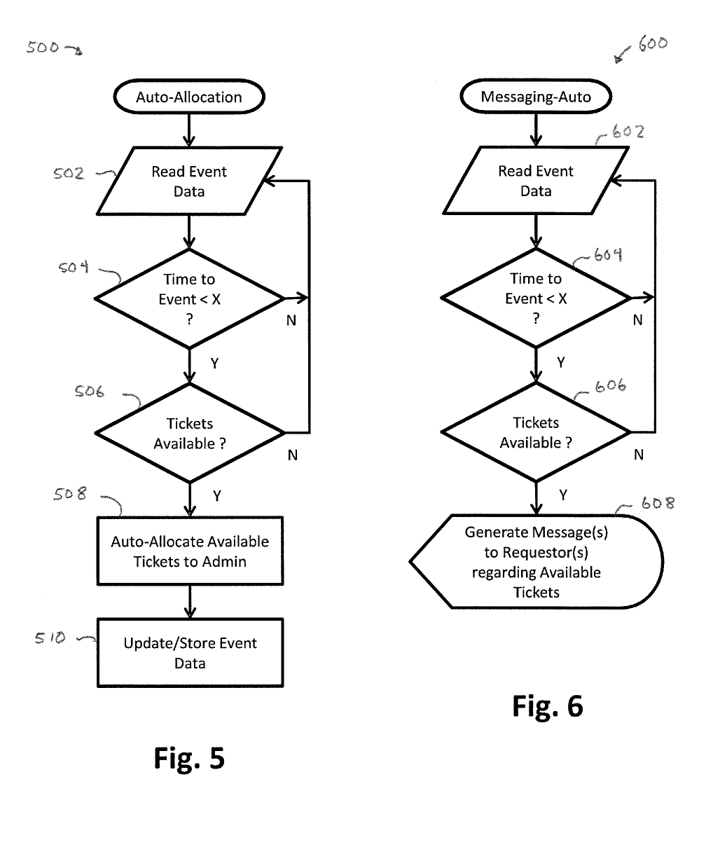

FIG. 5 illustrates one embodiment of auto allocation logic 500. One of the purposes of auto allocation logic 500 is to automatically allocate event tickets for which no requests had been made. The auto allocation indicates attention to these tickets is necessary so that they do not go unused. In one embodiment, the auto allocation can be to the administrators. The administrators would then invoke processes and/or procedures soliciting requests for these events. Hence, in this mode, the system no longer waits for requests to be made, but instead actively makes allocations (akin to grants) to the administrators for the active solicitation of requests.

In block 502, the logic reads event data to determine the time remaining to the event. In block 504, the logic determines if the time to the event is less than a threshold time (e.g., “X” days). If the time to the event is less than this threshold, the logic advances to block 506 where it reads event data to determine if tickets are available for request. If tickets are available for request, the logic advances to block 508 where the available tickets are automatically allocated (i.e. granted) to the administrators. In block 510, updates and stores the event data to indicate that an auto allocation to the administrators has occurred. This information can be used for subsequent event reporting and usage analysis. If in either block 504 or 506 the condition listed is not met, the logic loops back to read the event data for the next event.

Referring now to FIG. 6, automatic messaging logic 600 is illustrated. In one embodiment, the automatic messaging logic 600 functions to generate automatic messages to requesters and administrators of the availability of certain event tickets. For example, the logic may generate automatic messages to requesters and administrators listing all or some of the event tickets remaining available that are within the next 30 days. In other embodiments, different time windows may also be chosen and multiple time windows may be also employed.

In block 602, the logic reads event data which includes the date of the event and whether any tickets remain available. In block 604, the logic determines whether the remaining time to the event is less than a threshold value (e.g., 30 days). If the time remaining to the event is not less than 30 days, the logic loops back up to block 602 and reads event data for the next event. If the time remaining to the event is less than 30 days, the logic continues to block 606 where it determination is made whether any tickets remain available. If tickets are available, the logic advances to block 608 and generates one or more messages to requesters and/or administrators regarding the availability of event tickets. If tickets are not available in block 606, the logic loops back to block 602 and reads the event data for the next event.

In one embodiment, the message(s) generated in block 608 can include a listing of all (or total) available event tickets with associated event data such as, for example, the name of the event, the number of tickets available, the time and date of the event, etc. The message can also include interactive links allowing the requesters to directly link to the event to make a request. In other embodiments, the message(s) in a threshold value (e.g. 30 days) may be tiered. For example, based on the profile of certain requesters, a larger window of time or threshold value such as, for example, 45 days may be used. In addition, or alternatively, based on the profile of certain other requesters, a smaller window of time or threshold value such as, for example, 14 days may be used. In this manner, any appropriate window of time or threshold value may be selected and tied to requester profiles. Also in this manner, the automatic messaging logic 600 may be run at different times for different requester profiles.

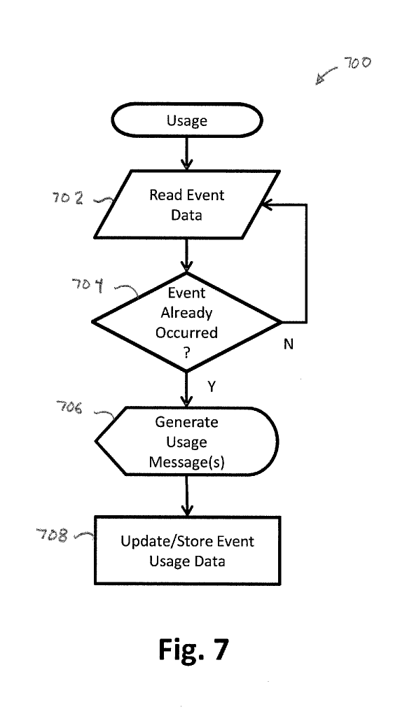

FIG. 7 illustrates a high level flowchart and logic 700 for collecting and storing usage data for each event. In one embodiment, logic 700 determines if the date of an event has passed and generates one or more messages to requester(s) that have been granted tickets and requests usage data from the requester(s). The message can include, for example, event data (e.g., name of the event, time and date, etc.) and an interactive link to an event usage form (e.g., FIG. 15). The usage data can include, for example, the attendee names, their affiliations, notes, and topics discussed. Additional or fewer data may be collected and additional relevant data may also be collected. The usage data is then stored and used for record-keeping and usage reporting.

Still referring to FIG. 7, the logic 700 reads event data that include the time and date of the event in block 702. In block 704, the logic determines if the date of the event has passed. If the date has passed, the logic advances to block 706 and generates one or more messages to the requestor(s) that have been granted tickets to the event requesting that they provide usage data. In one embodiment, the messages are emails identifying the event and include an interactive link to usage data input display or function (e.g., FIG. 15). If the requestor(s) have not completed the usage data input by a certain time period, the logic can generate additional similar emails reminding the requestor of the need to complete the event usage data. Upon completion of the event usage data, the logic updates and stores the usage data for later use in block 708. The later use can include reporting, auditing, and data mining, for example.

FIG. 8 illustrates one embodiment of an event display 800. Event display 800 can include an event listing such as, for example, an event calendar 802. Display 802 further includes interactive tabs 804 and 806. Tab 804 links the event calendar 802 and tab 806 links to a display of the requester's list of event requests. Event calendar 802 includes a calendar matrix displaying the day of the month and interactive links to one or more events that occur on that day. For example, event 808 is shown as occurring on Sunday, December 1st. Events 810 and 812 are shown as occurring on Sunday, December 8th. Other events are similarly displayed. Furthermore, selecting any event (e.g., by mouse clicking, touching (tablet), voice command, etc.) brings up they display having detailed event data including, for example, the ability to request one or more tickets to the selected event. The calendar 802 can also be navigated to select different months through interactive navigation arrows displayed thereon. As previously mentioned, in other embodiments, event display 800 can take the form of an event listing or any other suitable format that allows viewing and selection of available events.

Referring now to FIG. 9, one embodiment of an event request display 900 shown. Display 900 can be in the form of a pop-up window or standalone new display. Display 900 includes an event data display portion 902 which can provide the name of the event, the time of event, and a description of the event. Display 900 also includes an interactive “Request Tickets” button. Display 900 further includes portion 906 for displaying existing request data associated with the event. For example, display portion 906 can display existing requests by the same, selected, or all requesters for this event if any exist.

FIG. 10 illustrates one embodiment of a new ticket request display 1000. Display 1000 is interactive and can be a pop-up display or a new standalone display. In one embodiment, display 1000 includes several data fields for completion by the requester. These data fields can include the requester name (e.g., “Attorney” name), the specific type of seats requested, the client or prospect name for which the tickets are intended to be used, and a field for intended attendee names and/or other notes. These data fields may be in the form of populated drop-down menus, text boxes, or any other suitable input form. Upon completion of the new ticket request input fields, a requester can “submit” the request into the system for processing (as described earlier).

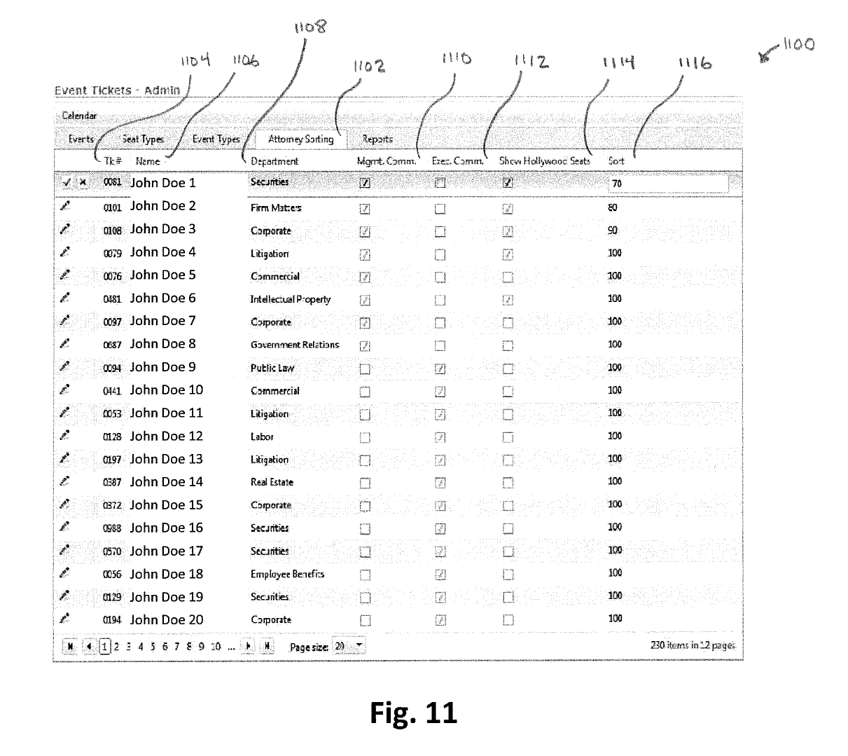

Referring now to FIG. 11, one embodiment of a requester profile display 1100 shown. Display 1100 is typically use by the administrators to manage the profile of one or more recognized requesters. Display 1100 includes a “sorting” tab that launches the display. In display 1100, several requester data fields are available for display and modification. These include an reference or employee number (“Tkt#”) 1104, Name 1106, Department 1108, group/committee affiliation (e.g., Mgmt. Comm. 1110, Exec. Comm. 1112), Show Hollywood Seats 1114, and Sort (e.g., seniority or rank) 1116. These fields are not intended to be exhaustive and additional or fewer of these fields can be used. For example, the group/committee affiliation field can include fields such as director, officer, manager, vice president, etc. Also, data fields such as “Show Hollywood Seats” 1114 can be used to manage the availability or access to certain tickets for that particular requester profile. For example, tickets to certain events may be limited to certain groups of requestors, such that the requester can only view and/or can only initiate requests for tickets to events available to that requester. In addition, messages associated with event ticket requests from certain group members may be identified as such, for example, with a “high priority” message/email status/designation. Further, the “sort” field can be used to indicate the seniority or rank of a requester profile in order to manage how requests are prioritized and how privileges are managed. For example, requester profiles with a lower sort value can be given a higher priority and granted wider visibility and accessibility to request event tickets compared to requester profiles with higher sort values. Other embodiments of ranking and prioritizing may also be used. Administrators have access to display 1100 and the ability to modify or manage the profile of the requesters.

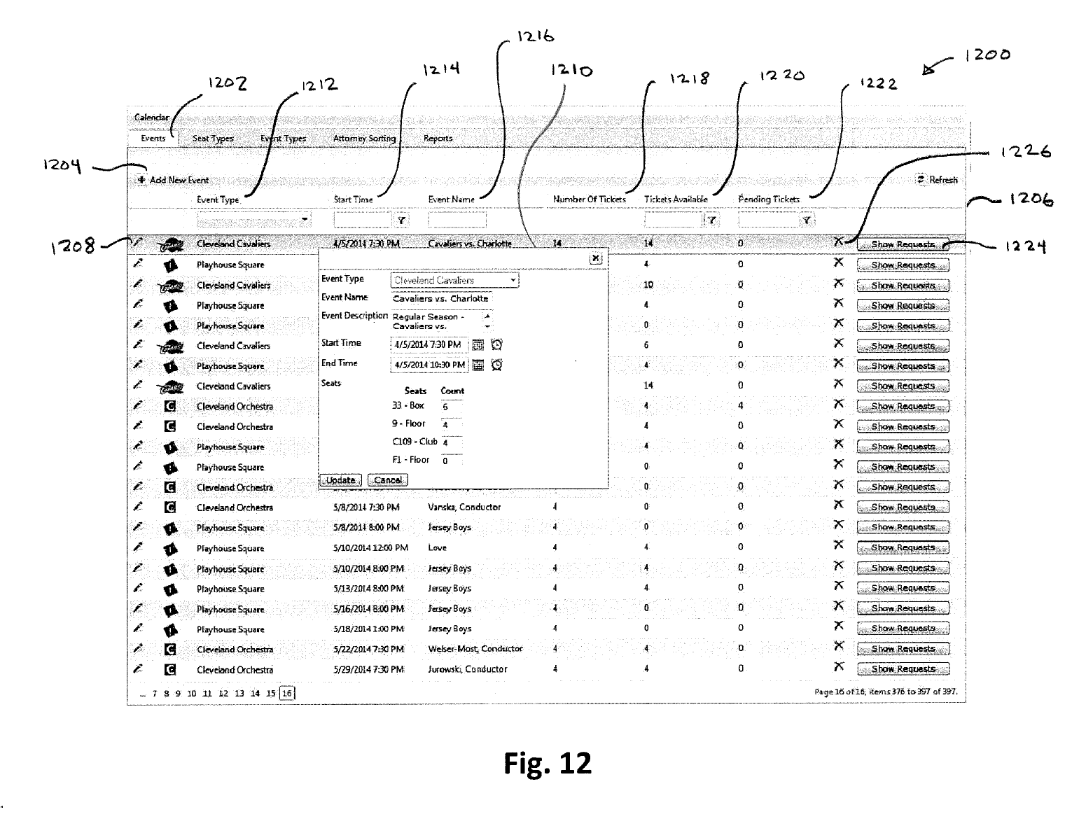

FIG. 12 illustrates of one embodiment an event management display 1200 showing an event listing 1206 and an event profile management display 1210. Event listing 1206 can be used by an administrator to, for example, manage the profile of a particular event. The display includes the button 1204 to add a new event to the list of events. Display 1206 also includes the ability to modify an existing event by modification button 1208. Selection of event modification button 1208 generates a display 1210 showing the data fields for the event that can be changed. These can include the type of event, name, description, start time, end time, and type and count of available seats. Administrators can modify these fields to update or change the data associated with a particular event.

Event listing display 1206 also includes further display of event data including the event type 1212, start time 1214, event name 1216, number of tickets 1218, number of tickets available 1220, and the number of pending ticket requests. In other embodiments, less event data fields can be displayed or fields in addition to those listed herein may be displayed. Event listing display 1206 also includes a “Show Requests” button 1224 and a delete event “X” button 1226. Selection of the “Show Requests” button 1224 generates a display showing all the requests that have been made for the event (e.g., see FIG. 14) In this embodiment, event listing display 1206 allows administrators to have a substantive view of a plurality of events, their associated event data, and a link to the event request information.

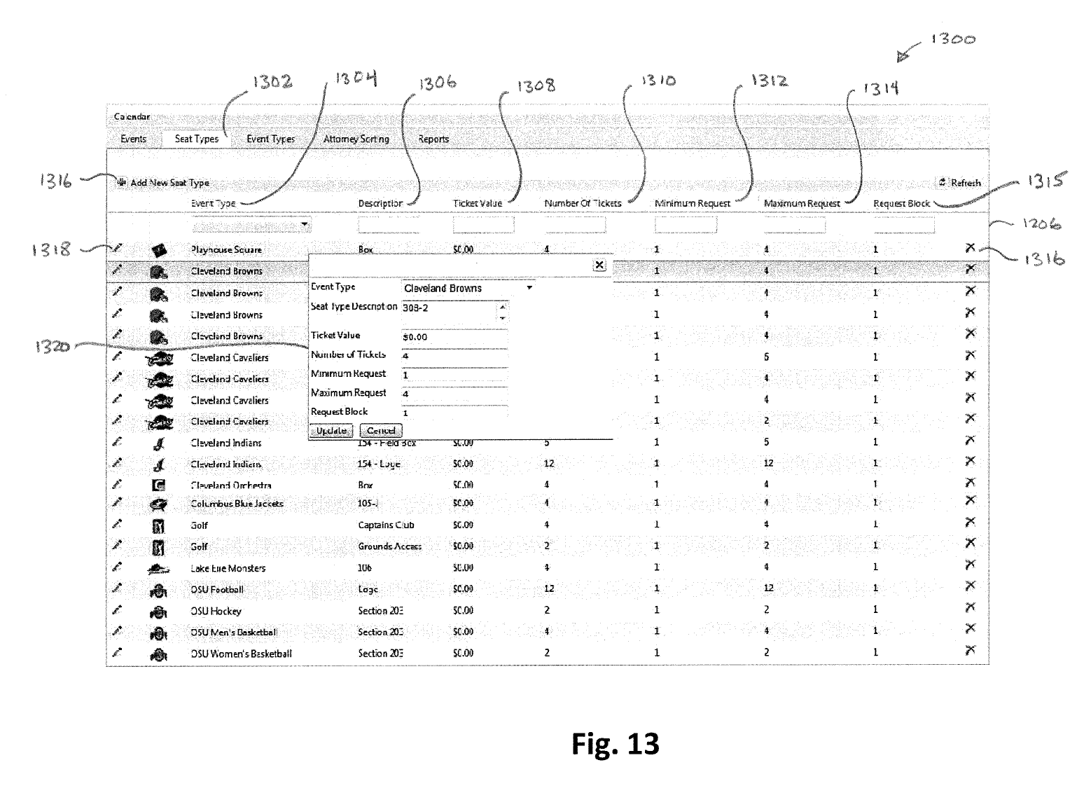

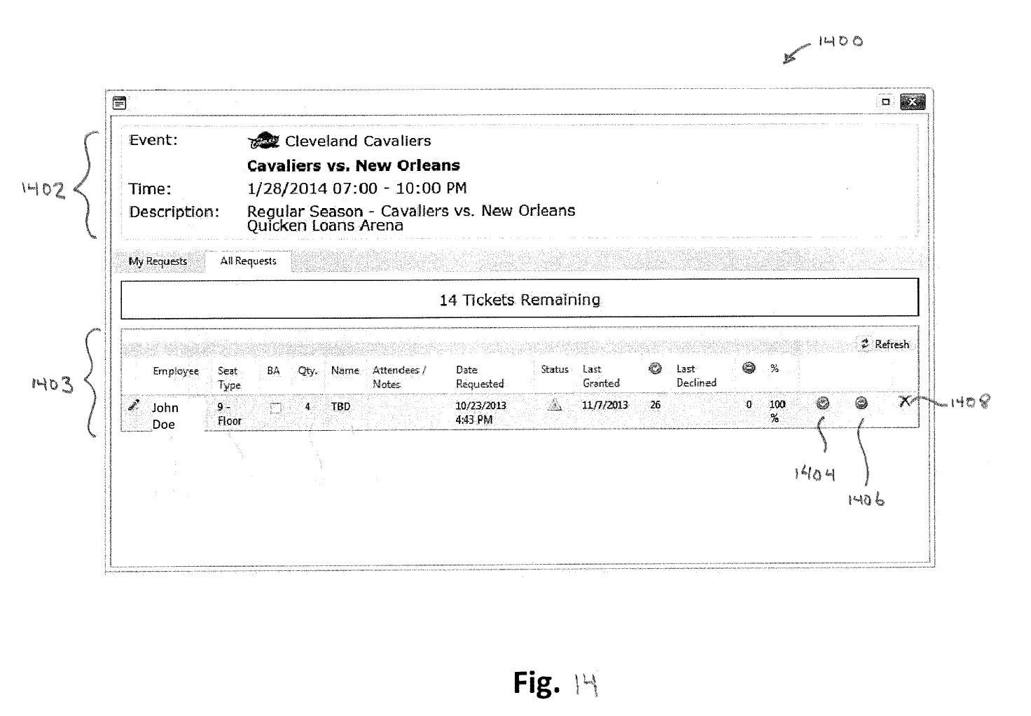

Referring now to FIG. 13, another embodiment of an event profile management display is shown at 1300. This display allows for management of event profile seating types. This includes seating definitions and associated data. Display 1300 includes an interactive “Seat Types” tab 1302 that triggers generation of the display. Display 1300 also includes listing of “Event Types” 1304, “Description” 1306 of the events, “Ticket Value” 1308, “Number of Tickets” 1310, “Minimum Request” 1312 for the type of seat tickets, “Maximum Request” 1314 for the type of seat tickets, and “Request Block” 1315 for setting the minimum block (or increment) of tickets that can be requested (e.g., 1, 2, 3, 4, etc.) Seat tickets can also be deleted through button 1316.

Display 1300 further includes an interactive button to “Add New Seat Type” 1316 and/or modify seat type 1318. If either of these are selected a display 1320 is generated where data associated with the new or modified seat type can be input. These data includes “Event Type,” “Seat Type Description,” “Ticket Value,” “Number of Tickets,” “Minimum Request” and “Maximum Request” ticket values, and “Request Block” values. In other embodiments, additional or fewer of these data fields may be employed. For example, inputs for food service, club service, etc., can additionally included. In this manner, administrators can define and/or update seat/ticket profiles associated with an event.

FIG. 14 illustrates one embodiment of an admin display 1400 for viewing and/or making decisions regarding requests. These decisions including granting, denying and/or deleting requests. Display 1400 includes event data 1402 and request data 1403. Request data 1403 includes the name of the requestor or “Employee,” the “Seat Type” requested, the quantity requested “Qty.”, the name of the planned attendee and notes “Attendee/Notes,” the “Date Requested,” the status of the request “Status,” the date of the last grant to this requestor “Last Granted,” the date of the last denial to this requestor “Last Denial,” the number of granted requests “√,” the number of denied requests “−,” the total number of requests, and the percentage of grants to the total number of requests “%.” In other embodiments, addition or fewer of this data may be used.

Display 1400 also includes grant button 1404, deny button 1406, and delete button 1408. These buttons are used by, for example, administrators to grant, deny and/or delete pending requests. When a decision regarding a request is made, the messaging logic generates message(s) to, for example, the requestor(s), informing them of the decision. Administrators may also be sent the same or similar message(s).

Referring now to FIG. 15, one embodiment of an usage display 1500 is shown. Display 1500 is generally used to capture event usage data. In one embodiment, requesters that have been granted event tickets are sent one or messages requesting that usage data be provided after the event has occurred. Display 1500 includes portion 1502 having event identification data and portion 1504 having inputs for usage data. Portion 1504 includes input fields for each event ticket granted to the requester. These fields include, for example, attendee indentifying information “Attendee,” their affiliation “Company,” notes “Notes,” and the “Nature of the Business Discussed.” As described throughout herein, addition or fewer data fields can used. After the data is input, it is stored for subsequent reporting and analysis.

The system and method of the present invention can be implemented on a variety of platforms including, for example, networked computer systems and stand-alone computer systems. Additionally, the logic and databases shown and described herein preferably reside in or on a computer readable medium such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, the displays and inputs of the present invention can be in any form suitable for obtaining the requested information. Furthermore, in other embodiments, the displays, logic, data, and inputs do not need to have the exact form, number or type as described herein, but can include less than that described herein. Alternatively, additional displays, logic, data and inputs can also be utilized that are consistent with managing a plurality of events. In addition, the invention may be a part of a larger business development activity tracking and/or management system, wherein event ticket management is one of many business development activities. For example, the business development system and method of U.S. provisional application Ser. No. 62/021,943, which is incorporated by reference herein in full.

Therefore, the invention, in its broader aspects, is not limited to the specific details, the representative apparatus, and illustrative examples shown and described. Accordingly, departures may be made from such details without departing from the spirit or scope of the applicant's general inventive concept.

The following is claimed:

1. A system for managing event tickets comprising:
a server having a memory comprising event ticket data and requester data;
logic generating an interactive list of available event tickets on one or more remote computers;
logic reading one or more electronic requests for event tickets from the one or more remote computers;
logic generating one or more electronic messages associated with the read electronic requests;
logic sending the one or more electronic messages to at least one or more administrators on the one or more remote computers;
logic reading one or more grant or deny signals from the at least one or more administrators associated with the read electronic requests; and
logic generating one or more electronic messages associated with the grant or deny signals.

2. The system of claim 1, further comprising:
logic sending the one or more electronic messages to at least one or more requesters.

3. The system of claim 1, further comprising:
logic displaying detailed event data based on a selection by a requester.

4. The system of claim 1, further comprising:
logic displaying a ticket request form based on a selection by a requester.

5. The system of claim 1, further comprising:
logic updating the event ticket data or the requester data based on the read grant or deny signals from the at least one or more administrators.

6. The system of claim 1, further comprising:
logic determining if the one or more read electronic requests is from a priority-based requester.

7. The system of claim 1, further comprising:
logic displaying a list of the read electronic requests and associated electronic links to grant or deny signals.

8. The system of claim 1, further comprising:
logic determining if a time until an event is less than a predetermined value;
logic determining if an event ticket is available for the event; and
logic allocating the event ticket to an administrator if the time until the event is less than the predetermined value and if the event ticket is available for the event.

9. The system of claim 1, further comprising:
logic determining if a time until an event is less than a predetermined value;
logic determining if an event ticket is available for the event;
logic generating one or more electronic event availability messages associated with the event if the time until the event is less than the predetermined value and if the event ticket is available for the event.

10. The system of claim 9, further comprising:
logic generating one or more electronic event availability messages to a first group of requestors when the time until the event is less than a first predetermined value; and
logic generating one or more electronic event availability messages to a second group of requestors when the time until the event is less than a second predetermined value.

11. The system of claim 1, further comprising:
logic determining if a date of an event has passed;
logic determining if an event ticket was allocated for the event; and
logic generating one or more electronic event usage messages associated with the event requesting event usage data if the date of the event has passed and if the event ticket was allocated for the event.

12. The system of claim 11, further comprising:
logic determining if a time since one or more electronic event usage messages was generated is more than a predetermined value;
logic generating one or more electronic event usage reminder messages requesting event usage data if the time since the one or more electronic event usage messages was generated is more than the predetermined value.

13. The system of claim 11, wherein the one or more electronic event usage messages includes an event usage form.

14. The system of claim 11, wherein the one or more electronic event usage messages includes a link to an event usage form.

15. The system of claim 11, further comprising:
logic storing the event usage data.

16. A system for managing event tickets comprising:
a server having a memory comprising event ticket data and requester data;
logic generating an interactive list of requesters on one or more remote computers;
logic displaying a plurality of data fields associated with the list of requesters, wherein the data fields comprise group identifiers;
logic reading one or more inputs from at least one or more administrators assigning a requester to a group in the group identifiers.

17. The system of claim 16, further comprising:
logic updating the requester data based on the group identifiers.

18. The system of claim 16, further comprising:
logic displaying one or more electronic requests for event tickets based on a priority-based group.

19. The system of claim 16, further comprising:
logic reading one or more inputs from at least one or more administrators assigning a requester a sort value in a sort field; and
logic displaying one or more electronic requests for event tickets based on one or more sort values.

20. A method for managing event tickets comprising:
reading one or more electronic requests for event tickets;
generating one or more electronic messages associated with the read electronic requests;
sending the one or more electronic messages to at least one or more administrators;
reading one or more grant or deny signals from the at least one or more administrators; and
generating one or more electronic messages associated with the grant or deny signals.
